(19) United States
(12) Patent Application Publication
(10) Pub. No.: US 2019/0118858 A1
(43) Pub. Date: Apr. 25, 2019

(54) ADAPTIVE WHEEL BASE REAR STEERING CONTROL

(71) Applicant: SCHAEFFLER TECHNOLOGIES AG & CO. KG, HERZOGENAURACH (DE)

(72) Inventors: Karen FLORES DE JESUS, Troy, MI (US); Shaun TATE, Grand Blanc, MI (US); Constantine MASTORY, Sterling Heights, MI (US)

(73) Assignee: SCHAEFFLER TECHNOLOGIES AG & CO. KG, HERZOGENAURACH (DE)

(21) Appl. No.: 16/163,943

(22) Filed: Oct. 18, 2018

Related U.S. Application Data
(60) Provisional application No. 62/576,183, filed on Oct. 24, 2017.

(51) Int. Cl. B62D 6/00; B62D 6/02; B62D 15/02

(52) U.S. Cl. CPC B62D 6/003; B62D 15/025; B62D 15/021; B62D 6/02

(57) ABSTRACT

A system in a vehicle comprising an actuator in the vehicle configured to adjust a rear wheel steering-angle of one or more rear wheels and a controller in the vehicle and in communication with the actuator, wherein the controller is configured to receive a vehicle speed and front-steering wheel angle from one or more sensors, and in response to vehicle speed and front-steering wheel angle, send a signal to the actuator to adjust the rear wheel steering-angle to reach a target yaw rate that correlates to the vehicle speed.

### CROSS-REFERENCE TO RELATED APPLICATIONS

This application claims the benefit of U.S. provisional application Ser. No. 62/576,183 filed Oct. 24, 2017, the disclosure of which is hereby incorporated in its entirety by reference herein.

### TECHNICAL FIELD

The present disclosure relates generally to adaptive rear steering systems and controls.

### BACKGROUND

Adaptive (or active) steering systems may include steering systems for a vehicle in which the relationship between the driver's steering inputs and the angle of the steered road wheels may be supplemented or adjusted, for example, using actuators. For adaptive rear steering, this may include adjusting the non-steered wheels (e.g., the rear wheels).

### SUMMARY

According to one embodiment, a system in a vehicle comprises one or more actuators in the vehicle configured to adjust a rear wheel steering-angle of one or more rear wheels and a controller in the vehicle and in communication with the actuator, wherein the controller is configured to receive a vehicle speed and front-steering wheel angle from one or more sensors, and in response to vehicle speed and front-steering wheel angle, send a signal to the actuator to adjust the rear wheel steering-angle to reach a target yaw rate that correlates to the vehicle speed.

According to a second embodiment, a vehicle system in a vehicle comprises a controller in communication with an actuator configured to adjust one or more rear wheels in the vehicle, wherein the controller is configured to send, in response to a vehicle speed and front-steering wheel angle, a signal to the actuator to adjust an angle of the one or more rear wheels until the vehicle reaches a target yaw rate that correlates to the vehicle speed.

According to a third embodiment, an actuator in a vehicle comprises a controller of the actuator configured to adjust one or more rear wheels in the vehicle in response to a signal sent from a vehicle controller requesting the rear wheels to adjust to a target angle in response to a speed and a front-steering wheel angle of the vehicle, wherein the target angle correlates to at least one of a target yaw rate, target yaw angle, or target lateral speed, wherein the target yaw rate, target yaw angle and target lateral speed are defined utilizing at least the vehicle speed.

### BRIEF DESCRIPTION OF THE DRAWINGS

FIG. 1 is a schematic diagram of a vehicle system including an adaptive steering system, according to an embodiment;

FIG. 2 is an example schematic block diagram 200 of the control system, according to an embodiment;

FIG. 3 is a schematic representation of the relationship between the speed of a vehicle and the wheel base of an adaptive reference model, according to an embodiment; and

FIG. 4 is a schematic diagram of a vehicle wheel base and its sub-components, according to an embodiment.

FIG. 5 is an example flow chart implementation in the control system, according to an embodiment.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

At the outset, it should be appreciated that like drawing numbers appearing in different drawing views identify identical, or functionally similar, structural elements. Furthermore, it is understood that this disclosure is not limited only to the particular embodiments, methodology, materials and modifications described herein, and as such may, of course, vary. As those of ordinary skill in the art will understand, various features illustrated and described with reference to any one of the figures can be combined with features illustrated in one or more other figures to produce embodiments that are not explicitly illustrated or described.

The terminology used herein is for the purpose of describing particular aspects only, and is not intended to limit the scope of the present disclosure, which is limited only by the appended claims. It is to be understood that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments.

Unless defined otherwise, all technical and scientific terms used herein have the same meaning as commonly understood to one of ordinary skill in the art to which this disclosure belongs. Although any methods, devices or materials similar or equivalent to those described herein can be used in the practice or testing of the disclosure, the following example methods, devices, and materials are now described.

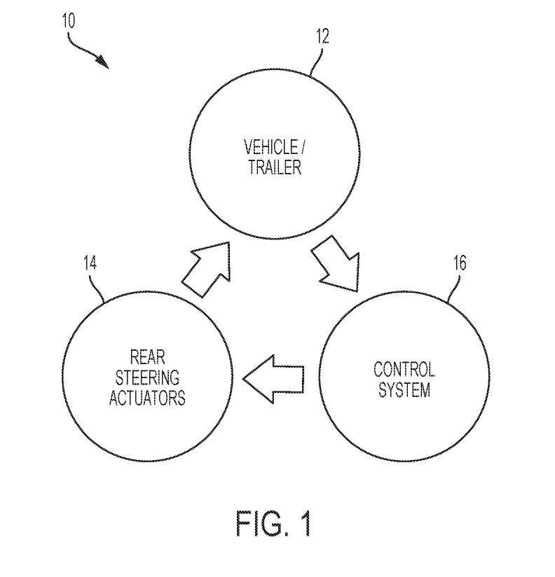

With reference to FIG. 1, a schematic of vehicle system 10 is shown that includes an adaptive steering system. The system 10 may include a vehicle 12, which may further be connected/attached to a trailer, one or more (e.g., a plurality) of steering actuators 14, which may be rear steering actuators, and a control system 16. The control system may include one or more controllers, which may each include a processor/CPU, RAM, non-volatile memory, and wired and/or wireless networking components. Control software may be stored in the non-volatile memory, which may include algorithms for operating the adaptive steering system. The one or more actuators 14 may have its own processor/controller that is utilized to communicate with the processor or controllers of the control system 16.

The control algorithms (or controller theory) may be configured to address one or more challenges. In one embodiment, the focus of the controller theory may be to mitigate trailer sway, for example, after evasive maneuvers or disturbances. In another embodiment the controller theory may be focused on low speed and high speed maneuvers, with or without a trailer attached to the vehicle. In at least one embodiment, the disclosed system and/or control algorithms may include both focuses, covering the whole spectrum of speeds and at the same time offering increased driver comfort, maneuverability, and/or safety.

In at least one embodiment, a state feedback controller is provided that is configured to control the rear steering mechanism of a vehicle. The goals of this system may be to reduce the turning circle of a vehicle, improve maneuverability at low speeds, increase stability at high speeds, and/or mitigate trailer sway caused by evasive maneuvers or other kinds of disturbances (or any combination thereof). It has been discovered that a controller that solely focuses on mitigating trailer sway may negatively influence the vehicle steering response under normal operation, since its target is to drive the trailer yaw rate and hitch angle as close to zero as possible. Similarly, it was discovered that a control technique that focuses on low/high speeds maneuverability only, may have no trailer sway mitigation capability, since it will generally be an open-loop based control. However, the disclosed controller may cover all the speed ranges and the tasks requirements.

In one embodiment, the state feedback controller is configured to allow a vehicle to track a pair of signals, such as a yaw rate and a lateral speed, through rear steering actuation. These two signals may be generated using an adaptive reference model that receives inputs, such as the steering wheel angle and vehicle speed.

In one embodiment, the reference model may be a bicycle model of the vehicle in question with variable parameters, such as the wheel base, vehicle mass, vehicle yaw inertia, and/or cornering stiffness (or any combination thereof).

Based on the vehicle speed, the algorithm may update the reference model parameters to reflect a target vehicle that the actual vehicle will follow. In one embodiment, at low speeds, a shorter wheel base vehicle is the target. Smaller vehicles generally mean tighter turns and better agility. At higher speeds, a longer wheel base vehicle may be the target, since longer vehicles generally mean smoother lane changes and a sovereign ride quality.

In addition, since the controller is configured to be a robust tracking controller, any disturbances to either the vehicle's yaw rate or lateral speed may be rejected and/or mitigated. This may occur simultaneously with the reference model updates. In other words, by adaptively modifying the wheel base of the reference model, the actual vehicle can be made to behave like a smaller class vehicle at low speeds and like a larger class vehicle at high speeds. As such, the constantly online controller may allow the vehicle to change operation characteristics based on its speed without sacrificing functionality.

The disclosed solution is a novel way of implementing reference model tracking using a state feedback controller for vehicle dynamics control. The overall system may include the vehicle/trailer 12, the rear steering actuators 14, and the control system 16, as can be seen in FIG. 1.

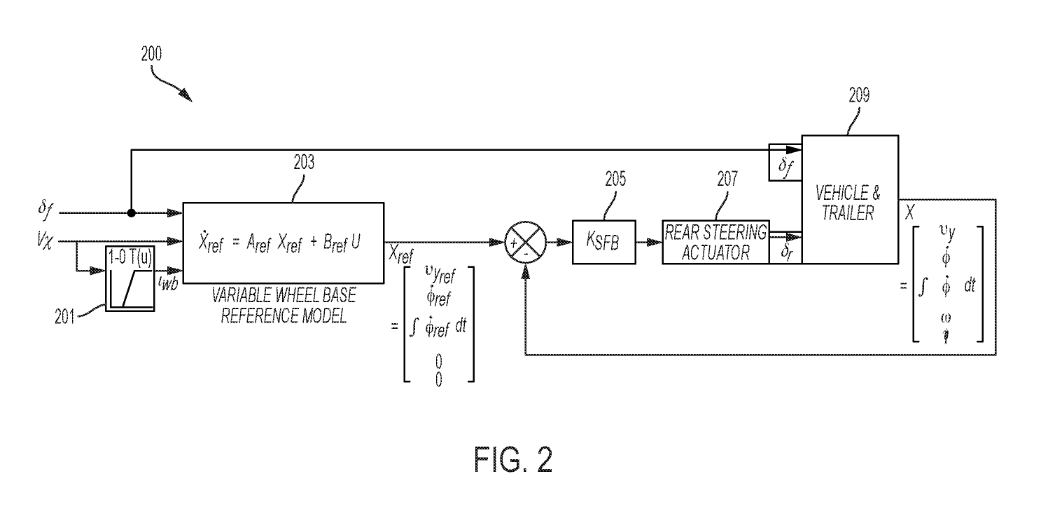

With reference to FIG. 2, an example schematic block diagram 200 is shown including details of the control system 16 defined by the state feedback controller with integral action and the adaptive reference model. One of ordinary skill in the art of dynamic modeling will understand the block diagram based on the present disclosure.

The forward vehicle speed may be fed to block 201, where the reference model wheel base is selected based on the vehicle speed. A sensor on the vehicle may be in communication with the controller to send the vehicle's speed. A look-up table may identify a reference wheelbase for the vehicle to mimic based on the vehicle speed. For example, if the vehicle speed is relatively low (e.g. less than a 40 km/h threshold), the look up table may identify a reference wheelbase for the vehicle to mimic. In this example, the reference wheelbase may have parameters/states to mimic a vehicle with a short wheelbase. If the vehicle speed is relatively high (e.g. more than an 80 km/h threshold), the look up table may identify a reference wheelbase for the vehicle to mimic. There may also be a transition threshold between a low speed and high speed. In this example, the reference wheelbase may have parameters/states to mimic a vehicle with a long wheelbase.

The front tires steering angle and the reference model wheel base are sent/communicated to block 203, the reference model (e.g., bicycle model) of a vehicle with a variable wheel base. The model calculates a reference states vector based on a reference model dynamics matrix, a reference model input matrix, and a reference model input. The reference states vector may include a reference lateral vehicle speed, reference vehicle yaw rate, and reference integral yaw rate. If a trailer is attached to the vehicle, a sensor located on the vehicle or trailer may send a signal to the controller indicating that the vehicle has a trailer attached. The controller may utilize that signal to consider parameters based on the trailer and compensate for the trailer states.

Block 205 includes state-feedback controller gains, which is then sent/communicated to block 207, the steering actuator model or hardware. The output of block 207 and the front tires steering angle are sent/communicated to block 209, the vehicle and trailer model or hardware. Data is then sent back to block 203 in the feedback loop. The signal sent between block 203 and 205 may be the error signal between the reference and the actual signals. The signal sent between block 205 and 207 may be the controller command signal that defines the degrees of rear wheel steering or the non-steered wheels of the vehicle. The computed error in the signal between block 203 and 205 may be multiplied by a set of gains that were evaluated based on a system model. Such gains may give weight to each computed error, allowing the actuators to respond in a predicted and desired manner. The output of the rear steering actuator 207 may be based on the controller command signal sent from block 205 to 207. Depending on the type of actuators used (their mechanism), the output could be a linear displacement (like the case of the front steering systems), a rotational displacement, etc. For generality we can say that the signal from block 207 is an achieved rear steering angle.

The vehicle/trailer states may be measured using on-board sensors and fed into the control system. The vehicle/trailer states may include the yaw rate and lateral speed of the vehicle, and the yaw rate and hitch angle of the trailer, when applicable. The rear steering actuators may be electro-mechanical devices that receive and execute commands from the control system and achieve the desired target position/speed through a lower level basic current control algorithm installed on their drivers.

The adaptive reference model may be a numerical bicycle model with a set of variable parameters. The inputs to the model may include the measured vehicle speed and steering wheel angle and the outputs of the model may include the reference lateral speed and yaw rate. The variable parameters may include the vehicle's wheel base, mass, yaw inertia, and/or cornering stiffness (or any combination thereof).

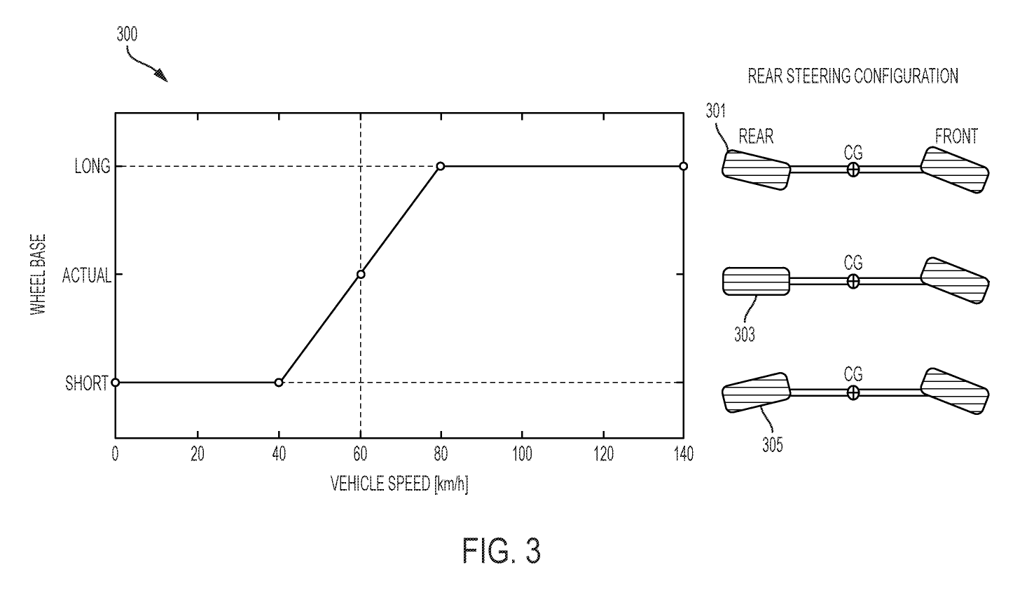

In one embodiment, the main adaptive parameter may be the wheel base, and the other parameters may be modified accordingly to maintain logical properties of the reference vehicle. In other words, a shorter wheel base means a smaller vehicle which will inherently have a lighter mass, lower inertia and cornering stiffness, and vice versa. The wheel base may be defined as a function of vehicle speed as shown in FIG. 3.

FIG. 3 is a schematic representation of the relationship between vehicle speed and the vehicle wheel base in an adaptive reference model, according to an embodiment. At 300 is a graph that plots a target wheel base to a vehicle speed (in km/h). The graph 300 may be utilized to adjust the rear wheel angle to achieve reference parameters to a vehicle with a different wheelbase than that of the current vehicle (e.g. longer or shorter wheel base). The target wheelbase may define the reference yaw rate, reference lateral speed, and reference yaw angle parameters for the vehicle to achieve handling/drivability to a vehicle that has a smaller or longer wheel base. As shown in FIG. 3, the target wheel base may be a long wheel base when the vehicle speeds are relatively higher, such as between 80 km/h to 140 km/h. For example, the target/reference wheel base may be longer when above a threshold, such a threshold may be 60, 65, 70, 75, 80, 85, 90, 95, or 100 km/h increments (or similar). Of course, any speed threshold may be utilized. In such a scenario, the rear wheel angle may adjust to an in-phase steering configuration 301. The adjustment to the rear wheel angle may allow the vehicle to achieve a reference yaw rate, reference lateral speed, and/or reference yaw angle to that of a vehicle with a longer wheelbase at the same speed as plotted on the graph. At a certain speed or between a low-speed threshold and high-speed threshold, the vehicle's parameters may equal those parameters of a reference vehicle without any adjustment to the wheel base. In such a scenario, the rear steering configuration 303 of the rear-wheel angle may be straight but the front-wheel angle may be adjusted. For example, the target wheel base may be a short wheel base when the vehicle speeds are relatively low, such as between 0 km/h to 40 km/h. In such a scenario, the rear wheel angle may adjust to an out-of-phase steering configuration 305. For example, the target/reference wheel base may be shorter when below a threshold, such a threshold may be 60, 65, 70, 75, 80, 85, 90, 95, or 100 km/h increments (or similar). Of course, any speed threshold may be utilized.

The target/reference wheelbase may not be constant and may be a function of the vehicle speed. As such, the slower the speed, the shorter the wheelbase (as defined by the wheelbase/vehicle speed graph) may be. In the inverse, the higher the speed, the longer the wheelbase (as defined by the wheelbase/vehicle speed graph) may be. Other vehicle parameters may be pro-rated based on the ratio of the selected wheelbase over the actual vehicle's wheelbase. For example, a shorter wheelbase vehicle (e.g. a coupe) shall not have the weight and inertia of a larger wheelbase vehicle (e.g. large SUV).

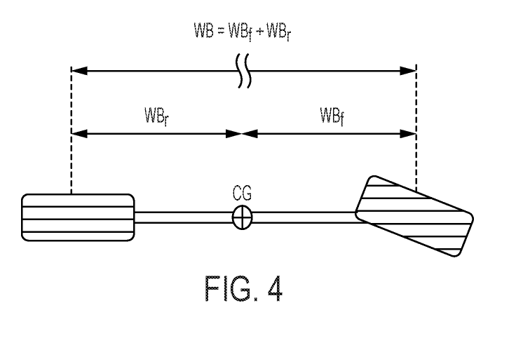

With reference to FIG. 4, in at least one embodiment, to maintain relative position of the center of mass of the vehicle with respect to the front and rear axles, the wheel base was divided into two lengths, namely WBf and WBr. The first, WBf, locates the vehicle center of mass from the front axle, whereas the second, WBr, locates it from the rear. The summation of the two will be equal to the overall reference vehicle wheel base.

The reference vehicle wheel base may then be divided by the actual vehicle wheel base, resulting in a normalized wheel base. When the reference is equivalent to the actual, the ratio is equal to 1, when it is shorter, the ratio is less than one, and when it is longer, the ratio is greater than one. This ratio may then be used to multiply WBf and WBr to scale them accordingly. This updating approach of the relative longitudinal positions of the vehicle's center of mass maintains a constant WBf/WBr for all reference models. The same scaling factor computed above may then be used to scale the reference vehicle mass, inertia and cornering stiffness. Accordingly, by feeding in the vehicle speed and front steering angle, the reference model may be updated automatically, supplying two reference signals that are proper to a target vehicle class and which need to be tracked by the actual vehicle.

In order to ensure a robust tracking of the generated signals by the adaptive reference model, the control system may include an augmented state feedback controller with integral action. It was discovered that a basic state feedback controller (SFC) based on the actual vehicle/trailer bicycle model suffered from steady state errors. To deal with steady state errors, the disclosed SFC may include an integral action such that the integral action gain is computed using the same pole placement technique as the other control gains. The state feedback controller may be utilized to counter act any errors in calculations.

In at least one embodiment, the controller may be always online whether there is a trailer attached to the vehicle or not. Since the controller's gains may change accordingly, two sets of gains may be evaluated. The first set may use the actual vehicle only bicycle model and the second may use the actual vehicle/trailer model. A flag or indicator that signals whether a trailer is attached or not may inform the algorithm of which set of control gains to use.

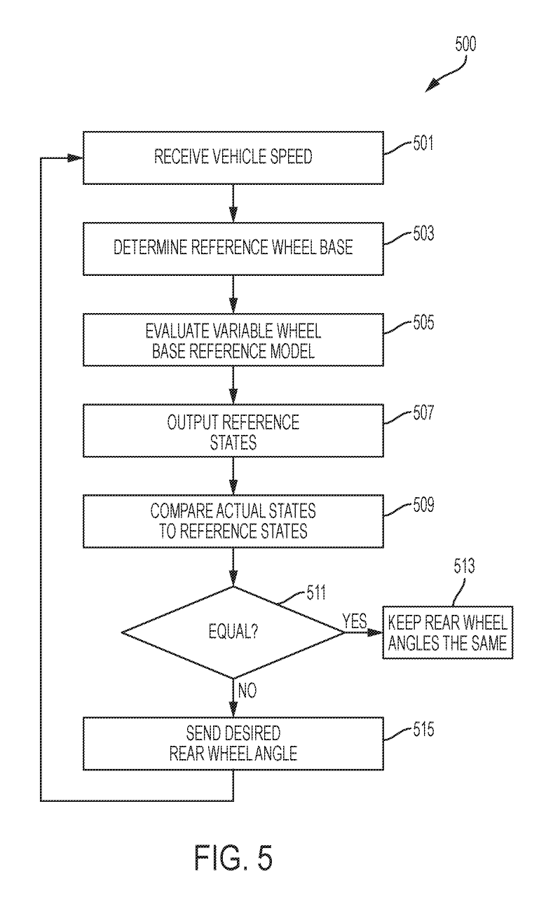

FIG. 5 is an example flow chart 500 implement in the control system, according to an embodiment. At step 501, the controller of the vehicle may receive a vehicle speed that defines a current speed that the vehicle is traveling. The vehicle speed may be determined and retrieved by another sensor or controller on the vehicle. The controller may utilize the vehicle speed to identify whether the vehicle's front and rear wheels should utilize an in-phase configuration (e.g. at high speeds) or an out-of-phase configuration (e.g. at lower speeds), or to not make any adjustments to the vehicles steering.

At step 503, the controller may calculate a reference wheelbase that the vehicle should attempt to mimic or achieve. The reference wheel base may be defined as a longer wheelbase when the vehicle is driving at a speed higher than a threshold speed. For example, a smaller vehicle (e.g. coupe or sedan) may attempt to mimic a reference wheel base of a larger vehicle (e.g. truck or sport utility vehicle) at a higher speed (e.g. freeway driving) since a vehicle with a larger wheelbase has smoother operation and drivability at higher speeds. In another scenario, the reference wheel base may be defined as a shorter wheelbase when the vehicle is driving at a speed lower than a threshold speed. For example, a larger vehicle (e.g. truck or sport utility vehicle) may attempt to mimic a reference wheel base of a smaller vehicle (e.g. coupe or sedan) at a lower speed (e.g. driving in a parking lot) since a vehicle with a smaller wheelbase may have a smaller turning radius than that of the larger vehicle. The reference wheelbase may be identified by a look-up table stored in memory that stores the reference parameters utilized to achieve handling to that of the reference wheelbase.

At step 505, the controller may evaluate a variable wheelbase reference vehicle model that the vehicle should attempt to mimic or achieve. The variable wheelbase reference vehicle model may be defined by a reference lateral vehicle speed, a reference vehicle yaw rate, and a reference integral of the yaw rate (e.g. yaw angle). The reference integral of the yaw rate may be utilized to minimize error attributed for the yaw angle. Thus, the vehicle may attempt to mimic the reference vehicle model by adjusting the rear wheels until the vehicle's actual parameters are equal to the reference lateral vehicle speed, reference vehicle yaw rate, and a reference yaw angle. The reference vehicle model may have various reference lateral vehicle speeds, reference vehicle yaw rates, and a reference yaw angle.

At step 507, the controller may output the reference states of the lateral vehicle speed, yaw rate, and a reference yaw angle. The output may go to a state-feedback controller to counteract any error. From there, the reference states may be utilized to send a signal to a rear steering actuator to adjust the angle of the rear wheels in an attempt to have the vehicle achieve the reference states of the reference vehicle model.

At step 509, the controller may compare the actual states to the reference states. For example, the controller may look to the lateral vehicle speed, yaw rate, and a yaw angle of the vehicle as compared to the reference states of the reference lateral vehicle speed, reference yaw rate, and reference yaw angle. If a vehicle trailer is attached, the trailer yaw rate, and trailer hitch angle may be compared to the reference trailer yaw rate and trailer hitch angle. In such a scenario, the system may allow for trailer sway mitigation with a minimum impact on the vehicle feel and driving response. In some scenarios, the reference signals for the trailer (e.g. hitch angle and trailer yaw rate) may be used at higher speeds. At lower speeds, the vehicle may only utilize the reference signals related to the vehicle, but not the trailer. For example, if a vehicle is traveling with a trailer at a low speed, the model may only utilize the reference states for the vehicle (yaw rate, lateral speed, and yaw angle).

At step 511, the controller may determine if the reference states are equal to the actual vehicle's states for the lateral vehicle speed, yaw rate, and yaw angle. When the controller has completed the comparison, it may determine whether to send a signal to the actuators to adjust the rear wheels. The signal sent by the controller may be a torque command to the motors of the actuator to adjust the rear wheels to a reference angle to achieve the reference states to mimic the reference vehicle model. However, no adjustment to the rear wheels may be made if the reference states are equal to the vehicle's current states. For example, at step 513, the vehicle's states for the lateral vehicle speed, yaw rate, and yaw angle may be equal to the reference vehicle's states for the reference lateral vehicle speed, reference yaw rate, and reference a yaw angle.

At step 513, the vehicle's states for the lateral vehicle speed, yaw rate, yaw angle may be equal to the reference vehicle's states for the reference lateral vehicle speed, reference yaw rate, and reference yaw angle. If the reference vehicle states are equal to the actual vehicle states, then the vehicle may not need the rear wheels to be further adjusted or adjusted at all. For example, the controller may have sent a signal to turn the rear wheels to allow the vehicle to achieve reference vehicle's states for the reference lateral vehicle speed, reference yaw rate, and reference a yaw angle. The rear wheels may have caused the reference states to be equal to the actual vehicle's states, thus no further adjustment is needed of the rear wheel's angle. In another scenario, the vehicle's references states are already equal to the vehicle's actual states prior to any adjustment. In such a scenario, the rear wheel angle may not need to be adjusted at all.

At step 515, the controller may send a signal to the actuator to adjust the rear wheel angle. The rear wheel angle may be adjusted to achieve the reference lateral vehicle speed, reference yaw rate, and reference a yaw angle. For example, the controller may send a signal to turn the rear wheels to allow the vehicle to achieve reference vehicle's states for the reference lateral vehicle speed, reference yaw rate, and reference a yaw angle. The rear wheels will turn until the reference parameters are met by the vehicle. Upon completion of sending the signal to the actuator to adjust the rear steering wheel angle, the system may repeat the previous steps until reference parameters for the vehicle are achieved. Thus, the signal sent by the controller may be a torque command to the motors of the actuator to adjust the rear wheels to a reference angle to achieve the reference states to mimic the reference vehicle model.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A system in a vehicle, comprising:
an actuator in the vehicle configured to adjust a rear wheel steering-angle of one or more rear wheels; and
a controller in the vehicle and in communication with the actuator, wherein the controller is configured to receive a vehicle speed and front-steering wheel angle from one or more sensors, and in response to vehicle speed and front-steering wheel angle, send a signal to the actuator to adjust the rear wheel steering-angle to a reach a target yaw rate that correlates to the vehicle speed.

2. The system of claim 1, wherein the controller is configured to receive from the one or more sensors a signal indicating that a trailer is attached to the vehicle.

3. The system of claim 2, wherein the controller is configured to receive a hitch angle of the trailer.

4. The system of claim 2, wherein the controller is configured to receive a trailer yaw rate of the trailer.

5. The system of claim 1, wherein the controller is further configured to adjust the angle of the rear wheels until the vehicle reaches a target yaw angle that varies based on the vehicle speed.

6. The system of claim 1, wherein the controller is further configured to adjust the angle of the rear wheels until the vehicle reaches a target lateral speed that varies based on the vehicle speed.

7. The system of claim 1, wherein the controller is further configured to adjust the angle of the rear wheels to an out-of-phase steering configuration when the vehicle speed is below a threshold.

8. The system of claim 1, wherein the controller is further configured to adjust the angle of the rear wheels to an in-phase steering configuration when the vehicle speed is above a threshold.

9. The system of claim 1, wherein the signal sent to the actuator to adjust the rear wheel steering-angle instructs an in-phase steering configuration.

10. The system of claim 1, wherein the signal sent to the actuator to adjust the rear wheel steering-angle instructs an out-of-phase steering configuration.

11. A vehicle system in a vehicle, comprising:
a controller in communication with an actuator configured to adjust one or more rear wheels in the vehicle, wherein the controller is configured to send, in response to a vehicle speed and front-steering wheel angle, a signal to the actuator to adjust an angle of the one or more rear wheels until the vehicle reaches a target yaw rate that correlates to the vehicle speed.

12. The vehicle system of claim 11, wherein the controller is further configured to adjust the angle of the rear wheels until the vehicle reaches a target yaw angle that varies based on the vehicle speed.

13. The vehicle system of claim 11, wherein the controller is further configured to adjust the angle of the rear wheels until the vehicle reaches a target lateral speed that varies based on the vehicle speed.

14. The vehicle system of claim 11, wherein the controller is further configured to adjust the angle of the rear wheels to create an out-of-phase steering configuration when the vehicle speed is below a threshold.

15. The vehicle system of claim 11, wherein the controller is further configured to adjust the angle of the rear wheels to create an in-phase steering configuration when the vehicle speed is above a threshold.

16. The vehicle system of claim 11, wherein the angle of the rear wheels creates an in-phase steering configuration.

17. The vehicle system of claim 11, wherein the angle of the rear wheels creates an out-of-phase steering configuration.

18. The vehicle system of claim 11, wherein the controller is further configured receive a signal indicating a trailer is attached to the vehicle and adjust the angle of the rear wheels of the wheel until the trailer reaches a target trailer-yaw rate that correlates to the vehicle speed.

19. The vehicle system of claim 11, wherein the controller is further configured receive a signal indicating a trailer is attached to the vehicle and adjust the angle of the rear wheels of the vehicle until the trailer reaches a target trailer-hitch angle that correlates to the vehicle speed.

20. An actuator in a vehicle, comprising:
a controller of the actuator configured to adjust one or more rear wheels in the vehicle in response to a signal sent from a vehicle controller requesting the rear wheels to adjust to a target angle in response to a speed and a front-steering wheel angle of the vehicle, wherein the target angle correlates to at least one of a target yaw rate, target yaw angle, or target lateral speed, wherein the target yaw rate, target yaw angle and target lateral speed are defined utilizing at least the speed of the vehicle.
